(19) United States
(12) Patent Application Publication
(10) Pub. No.: US 2026/0059259 A1
(43) Pub. Date: Feb. 26, 2026

(54) Ambiance Expansion System For A Vehicle

(71) Applicant: iBiquity Digital Corporation, Columbia, MD (US)

(72) Inventors: Daekyoung Noh, Huntington Beach, CA (US); Martin Walsh, Scotts Valley, CA (US)

(21) Appl. No.: 19/102,999

(22) PCT Filed: Aug. 10, 2023
(86) PCT No.: PCT/US2023/029974

§ 371 Date: Feb. 11, 2025

Related U.S. Application Data
(60) Provisional application No. 63/397,757, filed on Aug. 12, 2022.

(51) Int. Cl. H04S 7/00; H04S 5/00

(52) U.S. Cl. CPC H04S 7/305; H04S 5/00; H04R 2499/13; H04S 2400/05

(57) ABSTRACT

Generally disclosed herein is a mechanism to increase the perceived sound field width and depth in an automotive environment without causing excessive or unnatural reverberation. The audio ambiance may be added using a cross-analysis of a vehicle cabin and a typical room's sound decay characteristics. The late reverb insertion and extraction time may be determined from the target room response and the vehicle cabin response, and the late reverberation transfer function may be computed. Once the late reverberation transfer function is obtained, the combined cabin transfer function can be measured, and a scale factor for energy equalization derived. The total energy of the sound within the vehicle cabin may be normalized and the reverberation frequency spectrum may be equalized such that the late reverberation within the vehicle cabin is synthesized with the desired energy decay of the late reverberation of the sound in a room.

### BACKGROUND

The acoustic response (or impulse response) of a listening environment represents the way in which a sound propagates from an emitting sound source at one point and a recording source at another. The so-called room impulse response has three main components that differ over time. The direct source represents the direct path from the sound emitter to the sampled/recorded position. This direct source is usually the first recorded response and is often filtered by the effects of air absorption or objects diffracting or occluding the direct path. The next phase of the acoustic response represents sounds that have been reflected from nearby surfaces such as walls, floor, and ceiling, or any other reflective materials in the space. Eventually, these reflections will increase in density and decrease in amplitude as they continue to bounce around the listening space until such a point as they are perceived to be more diffuse and unlocalizable. This phase of the acoustic response is known as the late reverberation (or reverb).

The acoustic response of a listening environment is closely related to the size of the space within the listening environment. For example, the size of the space of a vehicle cabin is much smaller than the size of a typical room in a house or other dwelling. The acoustic response (e.g., reverberation) of sound in the vehicle cabin decays much faster than the acoustic response of a typical room. The sound that decays faster may cause a dry and unnatural sound field and a degraded listener experience. Further, the listener's experience may be affected because the reproduced sound in the vehicle cabin is perceived as relatively close to the listener, causing a less immersive listening experience.

Artificial reverberation can be added to solve the above problems. However, artificial reverberation will still interact with the natural acoustics of the cabin and may cause excessive and unnatural-sounding reverberation. Ideally, the acoustics of the cabin can be neutralized in order to minimize the interaction with artificial reverberation. For example, the room impulse response measured at the listening position may be deconvolved using digital signal processing before applying the artificial reverberation. However, this process is challenging as the target cabin impulse response will change as the listener moves their head and the nonminimum phase properties of the impulse response will make deconvolution almost impossible in practice.

### BRIEF SUMMARY

Generally disclosed herein is a mechanism to increase the perceived sound field width and depth in an automotive environment without causing excessive or unnatural reverberation. The audio ambiance may be added using a cross-analysis of a vehicle cabin and a typical room's sound decay characteristics. The late reverb insertion and extraction time may be determined from the target room response and the vehicle cabin response, and the late reverberation transfer function may be computed. Once the late reverberation transfer function is obtained, the combined cabin transfer function can be measured, and a scale factor for energy equalization derived. The total energy of the sound within the vehicle cabin may be normalized and the reverberation frequency spectrum may be equalized such that the late reverberation within the vehicle cabin is synthesized with the desired energy decay of the late reverberation of the sound in a room.

An aspect of the disclosure provides a method for expanding ambient sound for a vehicle. The method includes detecting impulse response of the vehicle; determining a late reverberation of the detected impulse response of the vehicle; extracting a late reverberation from a reference impulse response of a room; equalize an energy level of the extracted late reverberation of the vehicle to match an energy level of the extracted late reverberation of the room; and applying the energy level equalized late reverberation to the vehicle.

In another example, the method further includes limiting frequency bandwidths of the late reverberation extracted from the reference impulse response of the room.

In yet another example, the method further includes identifying additional late reverberation levels and decay times of one or more audio channels.

In yet another example, the identified additional late reverberation levels and decay times are used to derive multi-channel signals.

In yet another example, the method further includes applying the additional late reverberation levels and decay times to each of one or more audio objects.

In yet another example, the audio objects include dialogues, music and special effects.

In yet another example, applying the additional late reverberation levels and decay times includes separating sources of an input content when the input content is not object-based.

In yet another example, the method further includes applying the additional late reverberation levels and decay times based on listener preferences.

In yet another example, the method further includes applying the additional late reverberation levels and decay times based on content metadata.

Another aspect of the disclosure provides a system for expanding ambient sound for a vehicle. The system includes memory and one or more processors in communication with the memory and configured to: receive an energy level equalizer late reverberation, wherein the energy level equalizer late reverberation is derived by a process comprising: detecting impulse response of the vehicle, determining a late reverberation of the detected impulse response of the vehicle, extracting a late reverberation from a reference impulse response of a room, and equalizing an energy level of the extracted late reverberation of the vehicle to match an energy level of the extracted late reverberation of the room; and apply the energy level equalized late reverberation to the vehicle.

In another example, the one or more processors are further configured to limit frequency bandwidths of the late reverberation extracted from the reference impulse response of the room.

In yet another example, the one or more processors are further configured to identify additional late reverberation levels and decay times of one or more audio channels.

In yet another example, the identified additional late reverberation levels and decay times are used to derive multi-channel signals.

In yet another example, the one or more processors are further configured to apply the additional late reverberation levels and decay times to each of one or more audio objects.

In yet another example, the audio objects include dialogues, music and special effects.

In yet another example, applying the additional late reverberation levels and decay times includes separating sources of an input content when the input content is not object-based.

In yet another example, the one or more processors are further configured to apply the additional late reverberation levels and decay times based on listener preferences.

In yet another example, the one or more processors are further configured to apply the additional late reverberation levels and decay times based on content metadata.

In yet another example, the identified additional late reverberation levels and decay times are adjustable at a direct source level and one of the additional late reverberation levels.

In yet another example, the one or more processors are further configured to determine an extraction time index and insertion time index.

### BRIEF DESCRIPTION OF THE DRAWINGS

FIG. 1 depicts a flow diagram illustrating an ambiance expansion transfer function design process according to aspects of the disclosure.

FIG. 2 depicts a graph illustrating energy decay comparisons of vehicles and a room according to aspects of the disclosure.

FIG. 3 depicts a graph illustrating a sound energy decay difference between the energy-corrected processing and no energy-corrected processing according to aspects of the disclosure.

FIG. 4 depicts a graph illustrating an energy decay of the full ambiance expansion processing according to aspects of the disclosure.

FIGS. 5A-5B depict block diagrams illustrating an example direct and diffused level balance control for further enhancement of the perceived depth of the sound field according to aspects of the disclosure.

FIGS. 6A-6B depicts block diagrams illustrating an example multi-channel input and up-mixed input processing according to aspects of the disclosure.

FIG. 7 depicts a block diagram illustrating an example ambiance expansion system according to aspects of the disclosure.

### DETAILED DESCRIPTION

Generally disclosed herein is a system and method for synthesizing late reverberation with energy equalization based on cross-analysis of the late reverberation characteristics of the desired room and the vehicle cabin. The late reverberation insertion and extraction time index may be computed based on the vehicle cabin and the room impulse energy decay analysis. An energy equalization scale factor may be computed by comparing the energy of the synthesized late reverberation convolved with the vehicle's impulse response to the desired energy decay from the room acoustics. A room acoustic response may be equalized and filtered to limit the late reverberation frequency bandwidth and to create a natural timbre.

According to some examples, microphones may be used to capture the processed sound signals. The captured sound signal's energy decay may be compared to the room energy decay to generate a scale factor for equalizing the energy to match the target room's energy decay characteristics. The transfer function may be energy-equalized and filtered to be optimized by adding frequency spectrum equalization or frequency band limitation. The transfer function may be stored in a memory associated with the stereo unit in a design stage or at the point of manufacture.

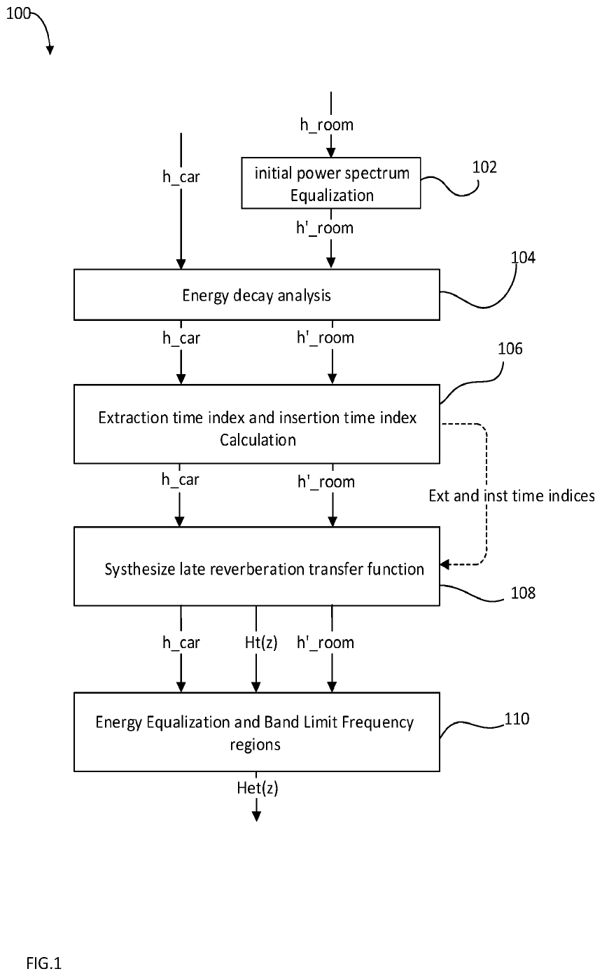

FIG. 1 depicts a flow diagram illustrating an ambiance expansion transfer function design process. According to block 102, the ambiance expansion system may receive an impulse response of a room (h_room). Impulse response may refer to a sonic measurement of the sound of a speaker, room, or microphone in relation to a sound source. Impulse response may also mean a combination of loud and short sound events used for testing the response to sound in a room or the effectiveness of an acoustical system. The room may be a typical room with one or two pieces of furniture and a home stereo system equipped within the room. In other examples, the room may be a large concert hall or a medium-size theatre. The impulse response of the room may be equalized to remove the influence of any capture and playback devices that may exist in the room.

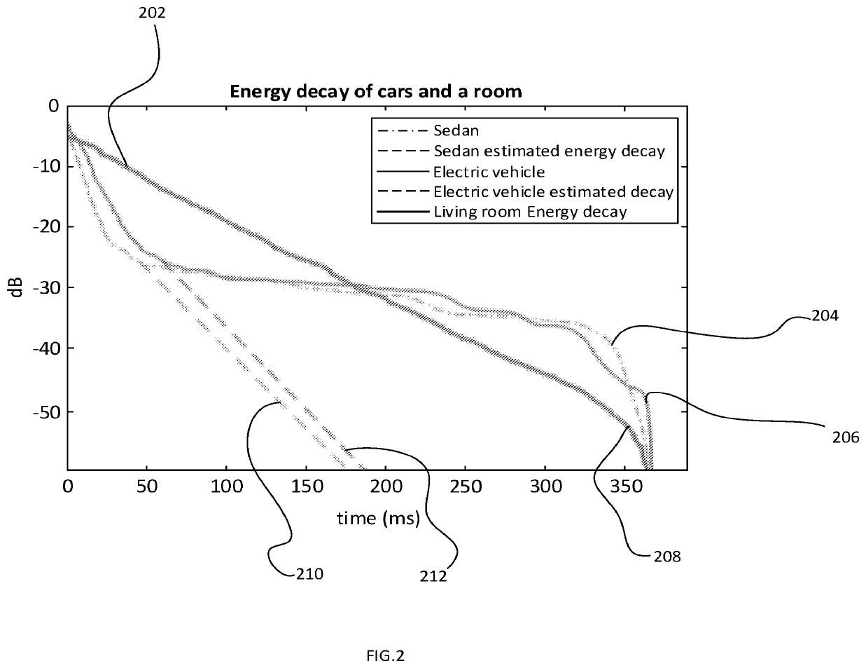

According to block 104, the ambiance expansion system may perform an energy decay analysis of the impulse response of a target vehicle (h_vehicle) and the equalized impulse response of the room. The impulse response of the vehicle may be measured in multiple seating positions for each sound output channel (e.g., left, right, or center channel). The various seating position data may be used to compute averaged data sets for each output channel. The energy decay analysis may be performed by estimating the envelope of a bandpass-filtered noise signal convolved by the impulse response of the vehicle and the impulse response of the room. According to some examples, the energy decay curve of each impulse response may be graphed and compared as illustrated in FIG. 2. Energy of a sound source may decay over time as the amplitude of a sound may progressively reduce as the sound reflects or bounces from the objects in an environment, such as vehicle seats, walls, doors, a windshield of a vehicle or any small to medium-sized objects or piece of furniture in an ordinary room. Energy of a sound source may also decay as the sound travels even without any reflections.

According to block 106, the ambiance expansion system may compute an extraction time index and an insertion time index. According to some examples, the late reverberation insertion and extraction time indices may be determined based on an energy decay analysis. For the purpose of this disclosure, late reverberation may refer to a later part of the energy decay curve of a sound source. Reverberation may refer to a stream of continuing sound and past the point of discernible early reflections may be referred to as late reverberation. There can be a few different methods to define the insertion and extraction time indices. For example, the time indices may be determined using the crossover point of the energy decay slope between the energy decay curve of the impulse response of the room and the impulse response of the vehicle. Another method may utilize the time index of the energy level of the vehicle's late reverberation starting point and use the late reverberation starting point as the insertion time index. The extraction time index may be calculated by finding the matching time index for the energy level of the insertion time index in the energy decay curve of the impulse response of the room. According to some embodiments, the extraction index satisfies the condition shown in the equation below.

$${EDC}_{car} ( {i}_{idx} ) = {EDC}_{room} ( {e}_{idx} ) , \qquad Equation 1$$

where EDC refers to energy decay curve, i_{idx} is late reverberation start time index of the vehicle and e_{idx} is late reverberation start time index of the room.

According to block 108, once the insertion and extraction time indices are determined, an initial transfer function of the late reverberation may be formed using the equation below.

$$Equation2$$

$${h}_{t} ( n ) = \{ \begin{matrix}1 , n = 0 \\ 0 , n = 1 - {i}_{idx} - 1 \\ {h}_{r}^{′} , n = {i}_{idx} - N , N = total length of the impulse response\end{matrix} \}$$

$${H}_{t} ( z ) = {h}_{t} ( 0 ) + {h}_{t} ( 1 ) {z}^{- 1} + … + {h}_{t} ( N ) {z}^{- N}$$

Ht(z) is the initial late reverberation transfer function. The energy decay curve of the output may be computed based on the energy level of the synthesized late reverberation using the initial late reverberation transfer function and the impulse response of the vehicle. According to some embodiments, the energy decay curve may be approximated by measuring the impulse response of the vehicle by capturing an excitation signal to which the initial translate reverberation transfer function is applied.

According to block 110, the energy level of impulse responses of the vehicle and room may be equalized, and the band of the frequencies may be limited. When the initial late reverberation transfer function is applied to the impulse response of the vehicle and the room, the processed output may create much higher output energy than desired. That is because the initial late reverberation transfer function is applied to the direct sound sources as well as the multiple reflections occurring in the vehicle. Therefore, the initial late reverberation transfer function may need to be scaled to match the extracted late reverberation energy of the room using the equation below.

$${E}_{ref} = \sqrt{\frac{1}{N} {\sum }_{n = {e}_{idx}}^{M + {e}_{idx} - 1} {\sum }_{k = n}^{N} {h}_{r}^{′2} ( k )} , \qquad Equation 3$$

where N is the length of the impulse response of the room and the impulse response of the vehicle, M=N−max(e_{idx}, i_{idx}).

$${E}_{syn} = \sqrt{\frac{1}{N} {\sum }_{n = {i}_{idx}}^{M + {i}_{idx} - 1} {\sum }_{k = n}^{N} {h}_{s}^{2} ( k )} ,$$

where hₛ is the impulse response of the vehicle processed with the initial late reverberation transfer function.

$$scale = {E}_{ref} / {E}_{syn}$$

The energy-equalized transfer function may be obtained by applying the above scale factor to the initial late reverberation of the transfer function. The energy-equalized transfer function may be obtained using the equation below.

$$Equation 4$$

$${h}_{t} ( n ) = \{ \begin{matrix}1 , n = 0 \\ 0 , n = 1 - {i}_{idx} - 1 \\ {h}_{r}^{′} , n = {i}_{idx} - N , N = total length of the impulse response\end{matrix} \}$$

$${H}_{et} ( z ) = {h}_{t} ( 0 ) + {h}_{t} ( 1 ) {z}^{- 1} + … + {h}_{t} ( N ) {z}^{- N}$$

$${H}_{et} ( z ) is the energy - equalized late reverberation transfer function .$$

FIG. 2 depicts a graph illustrating energy decay comparisons of vehicles and a room. Graph line 208 represents the energy decay of a sound in a living room. Reverberation time (RT) required to decay by 60 dB (RT60) of the living room is approximately 355 ms while the RT60s for the estimated energy decay of sedan 210 and the estimated energy decay of electric vehicle 212 are less than 200 ms. The decay time is shorter than that of the living room since the vehicle cabins have a relatively small volume and a lot of absorptive materials. The actual energy decay of the sedan 204 and the electric vehicle 206 are valid up to RT25 where the sound energy does not decay for the duration of approximately 200-250 ms as the measuring unit may capture the sound of the engines and other noise made by the vehicles.

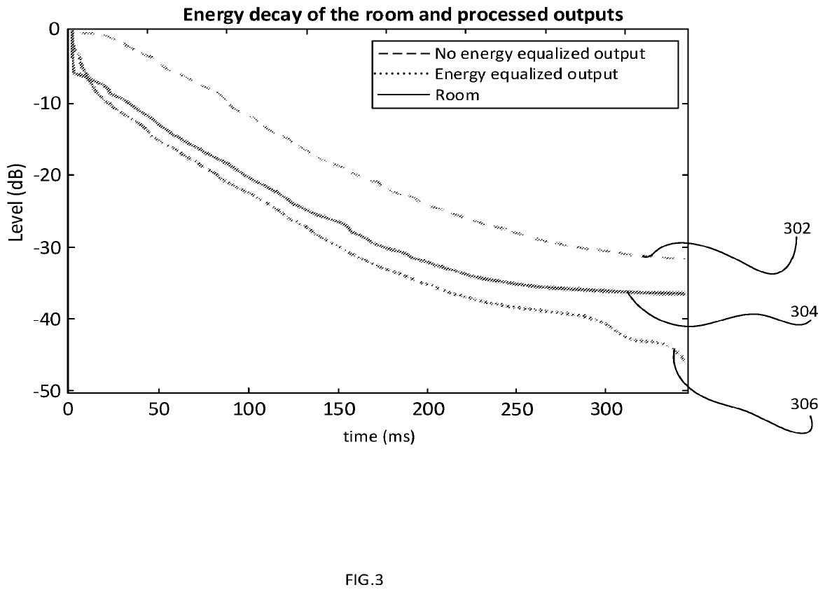

FIG. 3 depicts a graph illustrating a sound energy decay difference between the energy-corrected processing and no energy-corrected processing. Graph line 302 represents the energy decay of the impulse response of the vehicle processed with the initial late reverberation transfer function. The overall energy level of graph line 302 shows higher than that of graph line 304. Graph line 304 represents the energy decay of the living room. Graph line 306 represents the energy decay of the impulse response of the vehicle processed with the energy-equalized reverberation transfer function. The overall energy level of graph line 306 closely matches that of graph line 304, thereby making the sound in the vehicle similar to the acoustic sound measured in the living room.

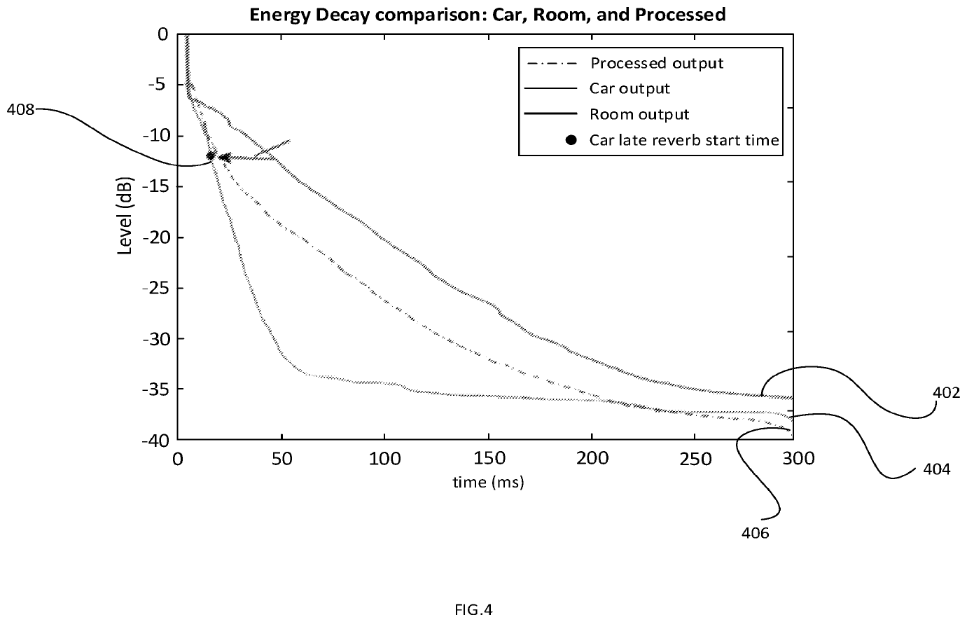

FIG. 4 depicts a graph illustrating an energy decay of the full ambiance expansion processing. Graph line 402 represents the energy decay of the sound in the living room and graph line 404 represents the energy decay of the sound in the vehicle. Graph line 406 represents the energy decay of the sound in the vehicle that is processed with the energy-equalized late reverberation transfer function. The late reverberation start time 408 represents where the late reverberation of the sound in the vehicle is extracted and the late reverberation of the living room is inserted. The late reverberation start time 408 may be computed based on the late reverberation time that aligns with the energy decay of the living room and the energy decay of the processed sound in the vehicle. Graph line 406 demonstrates that it does not change the vehicle's early reflection behaviors but only increases the energy decay time to have close late reverberation to the desired acoustics of the living room.

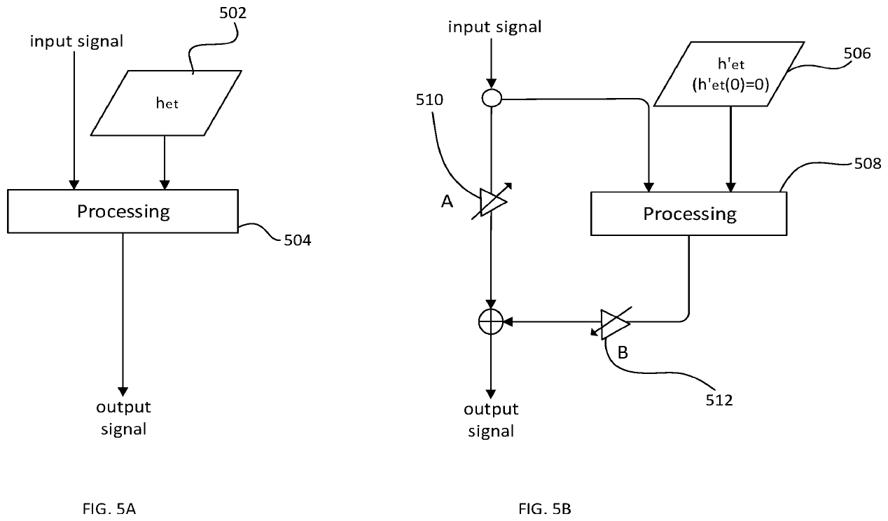

FIGS. 5A-5B depict block diagrams illustrating an example direct and diffused level balance control for further enhancement of the perceived depth of the sound field. After the energy-equalized late reverberation transfer function is applied, certain sound images may be degraded since reverberation, in general, can degrade the clarity of the sound source. For example, voice intelligibility may be impaired due to the direct application of the energy-equalized late reverberation transfer function to the input sound signal. In such examples, the expanded ambiance may be preserved while preserving the definition of each sound image by applying different energy decay curves of the late reverberation for each input sound signal or adjusting the ratio between the direct sound and the late reverberation. For example, FIG. 5A depicts an input sound signal processed at block 504. The ambiance expansion system applies the energy-equalized late reverberation transfer function 502 to each input sound signal at block 504. FIG. 5B depicts a diffused and direct processing of a single sound source. For example, a direct sound may proceed to gain line 510 such that only the gain level is adjusted. A diffused sound may proceed to block 508 to be processed with the energy-equalized late reverberation transfer function 506. The processed diffused sound may proceed to gain line 512 such that the gain level may be adjusted. By having separate gain controls of the direct and diffused sound, the clarity of the sound source may be adjusted effectively.

According to some embodiments, various later reverberation levels and decay times may be applied based on user preferences. Different later reverberation levels and decay times may be applied based on content metadata such as music genre. In some examples, the direct sound source and the late reverberation level may be adjustable using a graphical user interface.

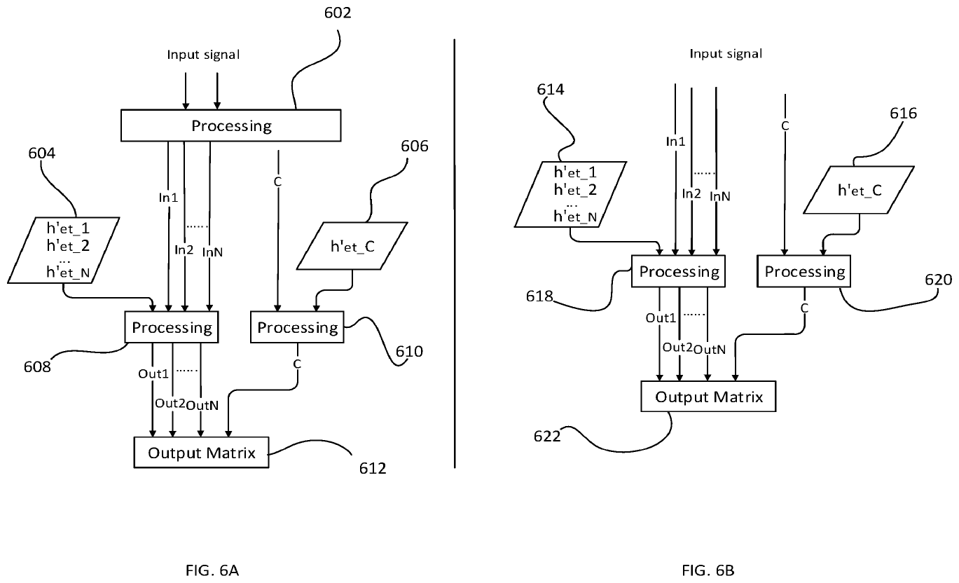

FIGS. 6A-6B depicts block diagrams illustrating an example multi-channel input and up-mixed input processing. According to some embodiments, a center channel of the multi-channel content may be processed with less late reverberation energy and a faster energy decay than the front left or right surround channels. Stereo content may be up-mixed to multichannel audio such that different ambiance characteristics may be applied as described for the multi-channel example. In other examples, source separation techniques may be used to extract each audio component from the mix (e.g., speaking voice) and each component may be processed with different amounts of reverberant energy.

Referring to FIG. 6A, a stereo input signal may be up-mixed at block 602 to derive multi-channel signals. The Center channel may be processed with the energy-equalized late reverberation transfer function 606 at block 610. Center channel may be processed independently of other channels since the center channel may include a vocal sound and the user may want to preserve vocal intelligibility. Other up-mixed channels may be processed at block 608 with corresponding energy-equalized late reverberation transfer functions 604. The processed channels may be combined at output matrix 612.

Referring to FIG. 6B, the center channel may be processed separately at block 620 and the energy-equalized late reverberation transfer function 616 may be applied. Other channels may be processed at block 618 with the corresponding energy-equalized late reverberation transfer functions 614. The processed channels are combined at output matrix 622.

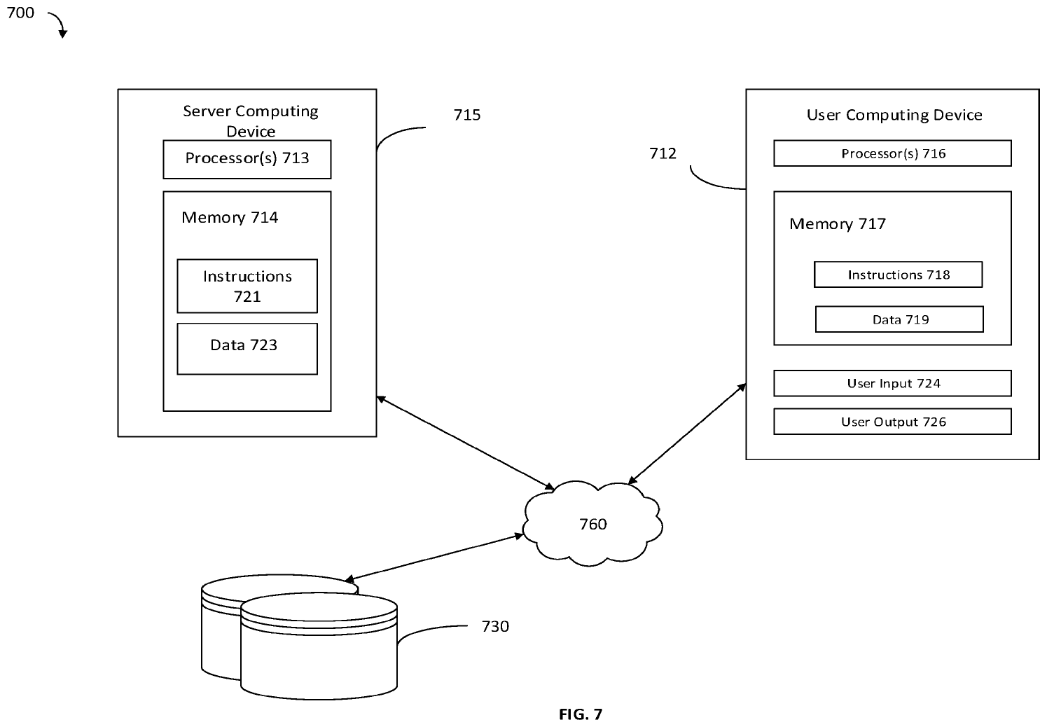

FIG. 7 depicts a block diagram of an example ambiance expansion system. User computing device 712 and server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer-readable medium capable of storing information, such as a hard drive, solid-state drive, tape drive, optical storage, memory card, ROM, RAM, DVD, CD-ROM, write-capable, and read-only memories.

The server computing device 715 can include one or more processors 713 and memory 714. Memory 714 can store information accessible by processor(s) 713, including instructions 721 that can be executed by processor(s) 713. Memory 714 can also include data 723 that can be retrieved, manipulated, or stored by the processor(s) 713. Memory 714 can be a type of non-transitory computer-readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), and/or application-specific integrated circuits (ASICs), such as tensor processing units (TPUs).

Instructions 721 can include one or more instructions that when executed by the processor(s) 713, cause one or more processors to perform actions defined by the instructions. Instructions 721 can be stored in object code format for direct processing by the processor(s) 713, or in other formats including interpretable scripts or collections of independent source code modules that are interpreted on demand or compiled in advance. Instructions 721 can include instructions for implementing processes consistent with aspects of this disclosure. Such processes can be executed using the processor(s) 713, and/or using other processors remotely located from the server computing device 715.

The data 723 can be retrieved, stored, or modified by processor(s) 713 in accordance with instructions 721. Data 723 can be stored in computer registers, in a relational or non-relational database as a table having a plurality of different fields and records, or as JSON, YAML, proto, or XML documents. Data 723 can also be formatted in a computer-readable format such as, but not limited to, binary values, ASCII, or Unicode. Moreover, data 723 can include information sufficient to identify relevant information, such as numbers, descriptive text, proprietary codes, pointers, references to data stored in other memories, including other network locations, or information that is used by a function to calculate relevant data.

User computing device 712 can also be configured similarly to the server computing device 715, with one or more processors 716, memory 717, instructions 718, and data 719. The user computing device 712 can also include a user output 726, and a user input 724. The user input 724 can include any appropriate mechanism or technique for receiving input from a user, such as a keyboard, mouse, mechanical actuators, soft actuators, touch screens, and microphones. User computing device 712 may interact with server computing device 715 to apply various later reverberation levels and decay times based on user preferences. Different later reverberation levels and decay times may be applied based on content metadata such as music genre. In some examples, the direct sound source and the late reverberation level may be sent from user computing device 712 to server computing device 715 using a graphical user interface. Server computing device 715 may store information relating to late reverberation levels and decay times of individual sound source based on the user's historic data.

Server computing device 715 can be configured to transmit data to the user computing device 712. The user output 726 can also be used for displaying an interface between the user computing device 712 and the server computing device 715. User computing device 712 may interact with a stereo system in a vehicle equipped with two or more speakers. User computing device 712 may control individual output channel's late reverberation level according to user preferences. The user output 726 can alternatively or additionally include one or more speakers, transducers, or other audio outputs, a haptic interface, or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of instructions 721, 718, and data 723, 719 can be stored on a removable SD card and others within a read-only computer chip. Some or all of the instructions and data can be stored in a location physically remote from, yet still accessible by, processors 713, 716. Similarly, processors 713, and 716 can include a collection of processors that can perform concurrent and/or sequential operations. Computing devices 715, and 712 can each include one or more internal clocks providing timing information, which can be used for time measurement for operations and programs run by computing devices 715, and 712.

The server computing device 715 can be configured to receive requests to process data from the user computing device 712. For example, environment 700 can be part of a computing platform configured to provide a variety of services to users, through various user interfaces and/or APIs exposing the platform services.

Devices 712, and 715 can be capable of direct and indirect communication over network 760. Devices 712, and 715 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. Network 760 can support a variety of short- and long-range connections. The network 760, in addition, or alternatively, can also support wired connections between devices 712, and 715, including over various types of Ethernet connection.

Although a single server computing device 715 and user computing device 712 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for expanding ambient sound for a vehicle, the method comprising:
detecting impulse response of the vehicle;
determining a late reverberation of the detected impulse response of the vehicle;
extracting a late reverberation from a reference impulse response of a room;
equalize an energy level of the extracted late reverberation of the vehicle to match an energy level of the extracted late reverberation of the room; and
applying the energy level equalized late reverberation to the vehicle

2. The method of claim 1, further comprising limiting frequency bandwidths of the late reverberation extracted from the reference impulse response of the room.

3. The method of claim 1, further comprising identifying additional late reverberation levels and decay times of one or more audio channels.

4. The method of claim 3, wherein the identified additional late reverberation levels and decay times are used to derive multi-channel signals.

5. The method of claim 3, further comprising applying the additional late reverberation levels and decay times to each of one or more audio objects.

6. The method of claim 5, wherein the audio objects include dialogues, music and special effects.

7. The method of claim 5, wherein applying the additional late reverberation levels and decay times includes separating sources of an input content when the input content is not object-based.

8. The method of claim 3, further comprising applying the additional late reverberation levels and decay times based on listener preferences.

9. The method of claim 3, further comprising applying the additional late reverberation levels and decay times based on content metadata.

10. A system for expanding ambient sound for a vehicle, the system comprising:
memory; and
one or more processors in communication with the memory and configured to:
receive an energy level equalizer late reverberation, wherein the energy level equalizer late reverberation is derived by a process comprising:
detecting impulse response of the vehicle,
determining a late reverberation of the detected impulse response of the vehicle,
extracting a late reverberation from a reference impulse response of a room, and
equalizing an energy level of the extracted late reverberation of the vehicle to match an energy level of the extracted late reverberation of the room; and
apply the energy level equalized late reverberation to the vehicle.

11. The system of claim 10, wherein the one or more processors are further configured to limit frequency bandwidths of the late reverberation extracted from the reference impulse response of the room.

12. The system of claim 10, wherein the one or more processors are further configured to identify additional late reverberation levels and decay times of one or more audio channels.

13. The system of claim 12, wherein the identified additional late reverberation levels and decay times are used to derive multi-channel signals.

14. The system of claim 12, wherein the one or more processors are further configured to apply the additional late reverberation levels and decay times to each of one or more audio objects.

15. The system of claim 14, wherein the audio objects include dialogues, music and special effects.

16. The system of claim 14, wherein applying the additional late reverberation levels and decay times includes separating sources of an input content when the input content is not object-based.

17. The system of claim 12, wherein the one or more processors are further configured to apply the additional late reverberation levels and decay times based on listener preferences.

18. The system of claim 12, wherein the one or more processors are further configured to apply the additional late reverberation levels and decay times based on content metadata.

19. The system of claim 12, wherein the identified additional late reverberation levels and decay times are adjustable at a direct source level and one of the additional late reverberation levels.

20. The system of claim 10, wherein the one or more processors are further configured to determine an extraction time index and insertion time index.
